(19) United States
(12) Patent Application Publication
(10) Pub. No.: US 2024/0109150 A1
(43) Pub. Date: Apr. 4, 2024

(54) METHOD AND APPARATUS FOR THE LASER PROCESSING OF A WORKPIECE

(71) Applicant: TRUMPF Laser- und Systemtechnik GmbH, Ditzingen (DE)

(72) Inventors: Jonas Kleiner, Leonberg (DE); Tim Hesse, Ditzingen (DE); Daniel Flamm, Ludwigsburg (DE)

(21) Appl. No.: 18/526,115

(22) Filed: Dec. 1, 2023

Related U.S. Application Data
(63) Continuation of application No. PCT/EP2022/063847, filed on May 23, 2022.

(30) Foreign Application Priority Data
Jun. 2, 2021 (DE) 10 2021 114 354.3
Sep. 15, 2021 (DE) 10 2021 123 801.3

(51) Int. Cl. B23K 26/06; B23K 26/046; B23K 26/067; B23K 26/53

(52) U.S. Cl. CPC B23K 26/0648; B23K 26/046; B23K 26/067; B23K 26/53

(57) ABSTRACT

An apparatus for laser processing of a workpiece is provided. The workpiece includes a transparent material. The apparatus includes a beam shaping device for forming a focus zone from an input laser beam. The focus zone is formed in elongate fashion in relation to a longitudinal axis. The focus zone has, in a plain perpendicular to the longitudinal axis, an asymmetric cross-section with a preferred direction. The apparatus further includes an actuating device for altering the preferred direction during the laser processing of the workpiece, and a control device for controlling the actuating device based on a predefined assignment specification in order to control the preferred direction by open-loop control or closed-loop control during the laser processing of the workpiece.

### CROSS REFERENCE TO RELATED APPLICATIONS

This application is a continuation of International Application No. PCT/EP2022/063847 (WO 2022/253606 A1), filed on May 23, 2022, and claims benefit to German Patent Application No. DE 10 2021 114 354.3, filed on Jun. 2, 2021, and German Patent Application No. DE 10 2021 123 801.3, filed on Sep. 15, 2021. The aforementioned applications are hereby incorporated by reference herein.

### FIELD

Embodiments of the present invention relate to an apparatus for laser processing of a workpiece, wherein the workpiece comprises a transparent material.

Embodiments of the present invention further relate to a method for the laser processing of a workpiece by means of a focus zone, wherein the workpiece comprises a transparent material.

### BACKGROUND

EP 3 311 947 B1 discloses a method for the laser processing of a transparent workpiece such as a glass substrate, for example, wherein the workpiece is processed by means of a pulsed laser beam having an elongate focus zone with a non-axisymmetric beam cross-section.

DE 10 2020 103 884 A1 discloses an apparatus for aligning a processing optical unit of a laser processing machine.

DE 10 2019 128 362 B3 provides a diffractive optical beam shaping element for imposing a phase distribution on a transverse beam profile of a laser beam.

WO 2020/212175 A1 discloses a processing optical unit for workpiece processing, comprising a birefringent polarizer element for splitting at least one input laser beam into a pair of partial beams polarized perpendicularly to one another, and a focusing optical unit arranged downstream of the polarizer element in the beam path and serving for focusing the partial beams onto focus zones.

### SUMMARY

Embodiments of the present invention provide an apparatus for laser processing of a workpiece. The workpiece includes a transparent material. The apparatus includes a beam shaping device for forming a focus zone from an input laser beam. The focus zone is formed in elongate fashion in relation to a longitudinal axis. The focus zone has, in a plain perpendicular to the longitudinal axis, an asymmetric cross-section with a preferred direction. The apparatus further includes an actuating device for altering the preferred direction during the laser processing of the workpiece, and a control device for controlling the actuating device based on a predefined assignment specification in order to control the preferred direction by open-loop control or closed-loop control during the laser processing of the workpiece.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of one exemplary embodiment of an apparatus for the laser processing of a workpiece;

FIG. 2 shows a schematic illustration of a further exemplary embodiment of an apparatus for the laser processing of a workpiece;

FIG. 3a shows a simulated intensity distribution of an asymmetric cross-section of a focus zone for the laser processing of the workpiece according to some embodiments;

FIG. 3b shows a schematic illustration of the intensity distribution of the asymmetric cross-section of the focus zone according to some embodiments;

FIG. 4 shows a schematic sectional view of material modifications in a material of the workpiece, wherein the material modifications are produced by the focus zone impinging on the material, according to some embodiments;

FIG. 5a shows a transverse phase distribution assigned to the intensity distribution in accordance with FIG. 3a at a beam exit side of a beam shaping element of the apparatus, according to some embodiments;

FIG. 5b shows a transverse far field intensity distribution assigned to the intensity distribution in accordance with FIG. 3a, wherein the focus zone is formed by focusing of this transverse far field intensity distribution, according to some embodiments;

FIG. 6 shows a schematic cross-sectional illustration of one exemplary embodiment of a polarization beam splitting element for forming partial beams with mutually different polarization states, according to some embodiments;

FIG. 7 shows a schematic cross-sectional illustration of a capturing device for optically capturing an actual preferred direction of the asymmetric cross-section of the focus zone formed, according to some embodiments;

FIG. 8 shows a schematic illustration of a capturing device for optically capturing a cross-section of material modifications in the material of the workpiece, which are formed by the focus zone impinging on the material, according to some embodiments;

FIG. 9a shows a micrograph of material modifications arranged in the material of the workpiece, said material modifications being produced by the focus zone impinging on the material, according to some embodiments; and

FIG. 9b shows a detail view of the partial region A in accordance with FIG. 9a, according to some embodiments.

### DETAILED DESCRIPTION

Embodiments of the present invention provide an apparatus and a method that can enable better control of a formation of material modifications in the material of the workpiece in order to realize in particular a separation of the material with a smoother separating surface.

According to some embodiments, the apparatus comprises a beam shaping device for forming the focus zone from an input laser beam, wherein the focus zone is formed in elongate fashion in relation to a longitudinal axis and wherein the focus zone, perpendicular to the longitudinal axis, has an asymmetric cross-section with a preferred direction, an actuating device for altering the preferred direction during the laser processing of the workpiece, and a control device for controlling the actuating device on the basis of a predefined assignment specification in order to control the preferred direction by open-loop control and/or closed-loop control during the laser processing of the workpiece.

For the laser processing of the workpiece, provision is made for the focus zone to be introduced into the material of the workpiece and moved relative to the material. As a result, material modifications are formed along a processing surface at which the material of the workpiece is separable, in particular.

The preferred direction of the cross-section of the focus zone is correlated with a preferred direction of a cross-section of material modifications which are formed in the material of the workpiece by means of the focus zone. The preferred direction of the material modifications formed can be controlled by way of provided open-loop control and/or closed-loop control of the preferred direction of the focus zone. As a result, the material modifications can be arranged and formed in particular in such a way as to enable a separation of the workpiece with the smoothest possible separating surface.

In particular, a preferred direction of material modifications that are able to be formed in the material by means of the focus zone can be controlled by means of the preferred direction of the focus zone, wherein in particular a principal direction of extent of cracks assigned to the respective material modifications can be controlled.

In particular, an automated open-loop control and/or closed-loop control of the preferred direction is provided by means of the control device.

In particular, the preferred direction of the asymmetric cross-section is controllable over an angle range of between 0° and 360°. By way of example, the assignment specification comprises an assignment which makes it possible to control the asymmetric cross-section in an angle range of between 0° and 360°.

By way of example, the preferred direction of the asymmetric cross-section is controllable with an angle interval of approximately 1/10° and/or in approximately 1/10° steps.

In particular, the focus zone forms a spatially continuous interaction region which is caused to interact with the material of the workpiece for the purpose of forming material modifications in the material.

In particular, the focus zone should be understood to mean a focused radiation region and in particular a spatially continuous radiation region of a laser beam with a specific spatial extent. In order to determine spatial dimensions of the focus zone, such as e.g. a diameter or a total length, only intensity values of the radiation region which lie above a specific intensity threshold are considered. In this case, the intensity threshold is chosen for example such that values below this intensity threshold have such a low intensity that they are no longer relevant for interaction with the material for the purpose of forming material modifications. By way of example, the intensity threshold is 50% of a global intensity maximum of the focus zone.

By way of example, the focus zone has a total length of between 50 μm and 5000 μm.

The beam shaping device is configured to form the focus zone in elongate fashion and with an asymmetric cross-section from the input laser beam, wherein the asymmetric cross-section has a preferred direction.

The fact that the focus zone is formed in elongate fashion should be understood to mean in particular that the focus zone extends in the direction of its longitudinal axis, and/or that the focus zone is formed in long-drawn-out and/or line-like fashion in the direction of the longitudinal axis. In particular, the focus zone has a largest spatial extent in the direction of the longitudinal axis.

The longitudinal axis of the focus zone is oriented in particular parallel to a principal direction of propagation of a laser beam from which the focus zone is formed.

By way of example, the longitudinal axis of the focus zone can be formed in curved fashion and/or as a curve and/or as straight.

The workpiece is formed for example in planar and/or sheetlike fashion. In particular, the longitudinal axis of the focus zone is oriented parallel or transversely to a thickness direction of the workpiece during the laser processing of the workpiece.

A cross-sectional plane of the asymmetric cross-section of the focus zone is oriented perpendicularly to the longitudinal axis of the focus zone.

The preferred direction of the asymmetric cross-section of the focus zone should be understood to mean in particular a direction in which the cross-section has a largest spatial extent and/or a largest diameter.

By way of example, the cross-section of the focus zone is formed at least approximately as an ellipse, wherein the preferred direction of the cross-section corresponds to a direction of a semi-major axis of the ellipse.

The assignment specification on the basis of which the actuating device is controlled by means of the control device during the laser processing of the workpiece is or comprises for example an assignment table and/or a mathematical function. The assignment specification can for example also be or comprise a constant (offset value).

It can be advantageous if the control device is configured to align the preferred direction during the laser processing at least approximately parallel to an advancement direction in which the focus zone is moved relative to the workpiece for the laser processing of the workpiece. As a result, for example cracks in the material of the workpiece that accompany the formation of material modifications can be aligned at least approximately parallel to the advancement direction. This results in particular in an overlap of cracks of material modifications adjacent to one another, which enables in particular a material separation with a smooth separating surface.

In particular, the control device is configured to carry out an automatic alignment of the preferred direction during the laser processing of the workpiece.

In particular, it can be provided that the focus zone has a quasi-nondiffractive and/or Bessel-like beam profile. As a result, the focus zone is formed in particular in elongate fashion.

In particular, it can be provided that for the purpose of forming the elongate focus zone and in particular for the purpose of forming the asymmetric cross-section of the elongate focus zone by means of the beam shaping device a transverse phase imposition on a beam cross-section of the input laser beam is effected.

In particular, it can be provided that the beam shaping device has at least one beam shaping element for the phase imposition of a transverse phase distribution on a beam cross-section of the input laser beam, wherein the phase distribution is chosen in order to form the focus zone in elongate fashion, and wherein the at least one beam shaping element is formed in particular as a diffractive optical element and/or as an axicon element.

In particular, the phase distribution is chosen in order to form the focus zone with a quasi-nondiffractive and/or Bessel-like beam profile.

A transverse direction lies in a plane oriented perpendicularly to the beam axis and/or principal direction of propagation of the input laser beam.

It can be advantageous if the phase distribution is chosen in such a way that the focus zone is formed with an asymmetric cross-section as a result of the imposition of the phase distribution by means of the at least one beam shaping element. As a result, the focus zone can be formed in elongate fashion and with an asymmetric cross-section for example by means of the same element of the apparatus. A rotation of the at least one beam shaping element then brings about in particular a change in the preferred direction of the asymmetric cross-section.

By way of example, an imposed phase distribution comprises a plurality of angle segments, wherein mutually adjacent angle segments have different azimuthal segment widths and/or a segment grating phase difference.

It can be advantageous if the at least one beam shaping element is influenceable by means of the actuating device for altering the preferred direction of the focus zone, and/or if the at least one beam shaping element is rotatable by means of the actuating device for altering the preferred direction of the asymmetric cross-section of the focus zone. As a result, the preferred direction can be altered and/or adjusted in a technically simple manner.

By way of example, the at least one beam shaping element, for altering the preferred direction of the asymmetric cross-section, is rotatable about an axis which is parallel or identical to the principal direction of propagation and/or to the beam axis of the input laser beam incident on the beam shaping element.

It can be advantageous if the beam shaping device has a polarization beam splitting element, by means of which partial beams having at least two mutually different polarization states are formed, wherein the focus zone is formed with an asymmetric cross-section as a result of the focusing of the partial beams. In particular, it is thereby possible to form the asymmetric cross-section of the focus zone on the basis of the principle of polarization beam splitting.

In particular, the polarization states are linear polarization states. By way of example, by means of the polarization beam splitting element, partial beams are formed with polarization states oriented perpendicularly to one another.

In particular, the polarization beam splitting element is formed for producing an angle offset and/or a position offset between the partial beams having mutually different polarization states.

The polarization beam splitting element is arranged in particular in a far field region and/or in a focal plane of the beam shaping device. In particular, a far field intensity distribution is formed in this far field region and/or in this focal plane, and is focused by means of a focusing optical unit of the beam shaping device for the purpose of forming the focus zone.

A rotation of the polarization beam splitting element brings about in particular a change in the preferred direction of the asymmetric cross-section of the focus zone.

It can be advantageous if the polarization beam splitting element is influenceable by means of the actuating device for altering the preferred direction of the focus zone, and/or if the polarization beam splitting element is rotatable by means of the actuating device for altering the preferred direction of the asymmetric cross-section of the focus zone.

By way of example, the at least one polarization beam splitting element, for altering the preferred direction of the asymmetric cross-section, is rotatable about an axis which is parallel or identical to the principal direction of propagation and/or to the beam axis of a laser beam incident on the polarization beam splitting element.

It can be advantageous if the beam shaping device has a beam stop for forming the asymmetric cross-section of the focus zone, by means of which beam stop an angle range of a far field intensity distribution formed by means of the beam shaping device is blocked, wherein a non-blocked portion of the far field intensity distribution is focused for forming the elongate focus zone with an asymmetric cross-section. In particular, a focusing optical unit of the beam shaping device is provided for focusing the non-blocked portion of the far field intensity distribution.

In particular, a rotation of the beam stop brings about a change in the non-blocked portion of the far field intensity distribution and/or a change in the preferred direction of the asymmetric cross-section of the focus zone.

In particular, the beam stop is arranged in a far field region and/or in a focal plane of the beam shaping device.

It can be advantageous if the beam stop is influenceable by means of the actuating device for altering the preferred direction of the asymmetric cross-section of the focus zone, wherein in particular an angle range of the far field intensity distribution that is non-blocked and/or blocked by means of the beam stop is alterable by means of the actuating device. Changing the blocked and/or non-blocked angle range of the far field intensity distribution brings about in particular a change in the preferred direction of the asymmetric cross-section.

By way of example, the beam stop, for altering the blocked and/or non-blocked angle range of the far field intensity distribution, is rotatable about an axis which is parallel or identical to the principal direction of propagation and/or to the beam axis of a laser beam incident on the beam stop. It is thereby possible to bring about in particular a change in the preferred direction of the asymmetric cross-section of the focus zone.

It can be advantageous if a far field intensity distribution is formed by means of the beam shaping device, wherein the focus zone is formed by the focusing of the far field intensity distribution and wherein the far field intensity distribution focused for forming the focus zone is influenceable by means of the actuating device in order to alter the preferred direction of the asymmetric cross-section of the focus zone. The far field intensity distribution can be influenced as described above, for example, by means of a beam shaping element and/or a beam stop of the beam shaping device.

In particular, the far field intensity distribution is arranged in a far field region assigned to the beam shaping device.

The far field intensity distribution comprises in particular a ring structure and/or ring segment structure, preferably having one or a plurality of concentric ring segments. In particular, the ring segments each have an identical radius. By way of example, the ring segments are arranged and/or formed concentrically in relation to a beam axis of a laser beam guided through the beam shaping device.

In particular, those angle ranges of the ring structure which are focused for the purpose of forming the focus zone are influenceable and/or definable by means of the actuating device.

In particular, the beam shaping device comprises a focusing optical unit and/or a telescope device in order to form the focus zone and/or in order to introduce the focus zone into the material of the workpiece. By way of example, by means of the focusing optical unit, the far field intensity distribution is focusable for the purpose of forming the focus zone. By way of example, by means of the telescope device, a laser beam coupled out from a beam shaping element of the beam shaping device is focusable for the purpose of forming the focus zone.

In particular, the apparatus comprises a laser source for providing the input laser beam, wherein the input laser beam provided by means of the laser source is in particular a pulsed laser beam and/or an ultrashort pulse laser beam.

In particular, the apparatus is designed to form the focus zone from the input laser beam and/or from an ultrashort pulse laser beam.

In particular, the focus zone is formed from an ultrashort pulse laser beam or provided by means of an ultrashort pulse laser beam.

For example, a wavelength of the input laser beam and/or of the laser beam from which the focus zone is formed is at least 300 nm and/or at most 1500 nm. For example, the wavelength is 515 nm or 1030 nm.

In particular, the input laser beam and/or the laser beam from which the focus zone is formed has an average power of at least 1 W to 1 kW. For example, the laser beam comprises pulses with a pulse energy of at least 100 and/or at most 50 mJ. Provision can be made for the laser beam to comprise individual pulses or bursts, with the bursts having 2 to 20 subpulses and in particular a time interval of approximately 20 ns.

The fact that the workpiece is formed from a transparent material should be understood to mean in particular that the material of the workpiece is produced from a material that is transparent to the input laser beam and/or from a material that is transparent to a laser beam from which the focus zone is formed.

A transparent material should be understood to mean in particular a material through which at least 70% and in particular at least 80% and in particular at least 90% of a laser energy of a laser beam from which the focus zone is formed is transmitted.

In particular, the focus zone interacts with the material of the workpiece by way of nonlinear absorption. In particular, by means of the focus zone, material modifications are formed in the material on account of nonlinear absorption.

In particular, it can be provided that the focus zone is configured to produce in the material of the workpiece material modifications which accompany cracking in the material of the workpiece and/or which are type III modifications.

The material modifications introduced into transparent materials by ultrashort laser pulses are subdivided into three different classes; see K. Itoh et al. “Ultrafast Processes for Bulk Modification of Transparent Materials” MRS Bulletin, vol. 31, p. 620 (2006): Type I is an isotropic refractive index change; type II is a birefringent refractive index change; and type III is what is known as a void or cavity. In this case, the material modification produced depends on laser parameters of the laser beam from which the focus zone is formed, such as e.g. the pulse duration, the wavelength, the pulse energy and the repetition frequency of the laser beam, and on the material properties such as, inter alia, the electronic structure and the coefficient of thermal expansion, and also on the numerical aperture (NA) of the focusing.

By way of example, the voids (cavities) of the type III modifications can be produced with a high laser pulse energy. In this context, the formation of the voids is ascribed to an explosion-like expansion of highly excited, vaporized material from the focal volume into the surrounding material. This process is also referred to as a micro-explosion. Since this expansion occurs within the mass of the material, the micro-explosion results in a less dense or hollow core (the void), or a microscopic defect in the sub-micrometer range or in the atomic range, which void or defect is surrounded by a densified material envelope. Stresses which may lead to spontaneous cracking or which may promote cracking arise in the transparent material on account of the compaction at the shock front of the micro-explosion.

In one embodiment, the apparatus comprises a capturing device for optically capturing an actual preferred direction of the asymmetric cross-section of the focus zone formed, wherein the capturing device is connected or is connectable in particular signal-effectively to the control device. By means of this capturing device, it is possible to determine in particular the assignment specification on the basis of which the control device controls the actuating device for the open-loop control and/or closed-loop control of the preferred direction.

It can be advantageous if the capturing device is configured for optically capturing the cross-section of the focus zone formed, and/or if the capturing device is configured for optically capturing a respective cross-section of material modifications produced in the material of the workpiece by the focus zone impinging on the material. It is thereby possible to determine in particular an actual preferred direction of the cross-section of the focus zone formed depending on different control signals with which the control device controls the actuating device.

In particular, it can be provided that the control device comprises a database and/or that the control device is assigned a database in which the assignment specification is stored. By way of example, the control device comprises a storage device and/or the control device is assigned a storage device in which the database with the assignment specification is stored.

According to some embodiments, a method provides that the focus zone is formed from an input laser beam by means of a beam shaping device, wherein the focus zone is formed in elongate fashion in relation to a longitudinal axis and wherein the focus zone, perpendicular to the longitudinal axis, has an asymmetric cross-section with a preferred direction, the preferred direction is altered or is alterable by means of an actuating device during the laser processing of the workpiece, and the preferred direction is controlled by open-loop control and/or closed-loop control by means of a control device during the laser processing of the workpiece, wherein the control device controls the actuating device on the basis of a predefined assignment specification.

The method according to embodiments of the invention in particular has one or more features and/or advantages of the apparatus according to embodiments of the invention. Advantageous embodiments of the method have already been explained in connection with the apparatus according to embodiments of the invention.

In particular, it can be provided that the focus zone impinges on the material of the workpiece and the focus zone is moved in an advancement direction relative to the material. In particular, material modifications arranged along a processing surface in the material are formed as a result.

In particular, the focus zone and/or the processing surface extend(s) over an entire thickness of the material.

By way of example, the focus zone is coupled into the material through an outer side of the workpiece, wherein in particular the focus zone is oriented transversely and in particular perpendicularly to this outer side.

In particular, it can be provided that the material of the workpiece is separable or is separated after laser processing has been effected, in particular by applying thermal loading and/or mechanical stress and/or by etching by means of at least one wet-chemical solution. By way of example, etching is implemented in an ultrasound-assisted etch bath. The workpiece is separated in particular at the material modifications formed and/or at the processing surface.

It can be advantageous if, by means of the control device, the preferred direction is aligned during the laser processing of the workpiece at least approximately parallel to an advancement direction in which the focus zone is moved relative to the workpiece for the laser processing of the workpiece.

It can be advantageous if, for defining the assignment specification, an actual preferred direction of the asymmetric cross-section of the focus zone formed is captured depending on a control signal, and is used by the control device to control the actuating device for controlling the preferred direction.

The actual preferred direction should be understood to mean in particular a resulting preferred direction and/or a real preferred direction of the asymmetric cross-section of the focus zone formed, which is optically capturable or is captured by means of a capturing device, in particular.

It can be advantageous if, for defining the assignment specification, the actual preferred direction of the asymmetric cross-section of the focus zone formed is varied by control of the actuating device by means of the control device over a specific range of orientation values and/or with an interval of orientation values. In particular, for this purpose, the actuating device is controlled by means of the control device with different control signals and in particular control signal values of the control signal.

It can be advantageous if, for determining the actual preferred direction, the cross-section of the focus zone formed is optically captured and the preferred direction of the optically captured cross-section is determined. In particular, the actual preferred direction is then determined on the basis of the focus zone formed, which is introduced or is introducible into the material. By way of example, the actual preferred direction is determined by optical and/or automated evaluation of the captured cross-section, in particular by means of image recognition and/or image data analysis.

It can be advantageous if, for determining the actual preferred direction, there is determined a preferred direction of a respective cross-section of one or a plurality of material modifications which were produced in the material of the workpiece by the focus zone impinging on the material. In particular, the actual preferred direction is then determined on the basis of a resulting interaction between the focus zone formed and the material of the workpiece. By way of example, the actual preferred direction is determined by optical and/or automated evaluation of the captured cross-section of the material modification, in particular by means of image recognition and/or image data analysis.

It can be advantageous if, for determining the preferred direction of the cross-section of a specific material modification, the corresponding material modification is optically captured.

In particular, it can be provided that the actual preferred direction of the cross-section of a specific material modification is determined by optically capturing cracks assigned to this material modification. By way of example, a principal direction of extent of the cracks is determined for the purpose of determining the preferred direction.

It has been found that the preferred direction of the cross-section of the material modifications actually formed can deviate from the actual preferred direction of the optically captured cross-section of the focus zone formed. Causes may be optical aberrations or secondary maxima lying around the asymmetric focus zone. Moreover, deviations may arise as a result of preferred directions of the material of the workpiece to be processed, e.g. in the case of a crystalline material. By determining the actual preferred direction on the basis of the preferred direction of the cross-section of material modifications which were produced in the material of the workpiece by the focus zone impinging on the material, it is possible to obtain good controllability and reproducibility of the preferred direction of the material modifications formed and in particular of the cracks of the material modifications formed.

In particular, it can be provided that the assignment specification is determined and/or is adapted and/or is optimized before or during or after the laser processing of the workpiece.

In particular, a part of the apparatus that is referred to as an element in this application, such as e.g. a beam shaping element or a polarization beam splitting element, can comprise in each case a plurality of subcomponents and/or subelements.

In particular, the indications “at least approximately” or “approximately” should be understood to mean in general a deviation of at most 10%. Unless stated otherwise, the indications “at least approximately” or “approximately” should be understood to mean in particular that an actual value and/or distance and/or angle deviates by at most 10% from an ideal value and/or distance and/or angle, and/or that an actual geometric shape deviates by at most 10% from an ideal geometric shape.

Elements which are the same or have equivalent functions are provided with the same reference signs in all of the figures.

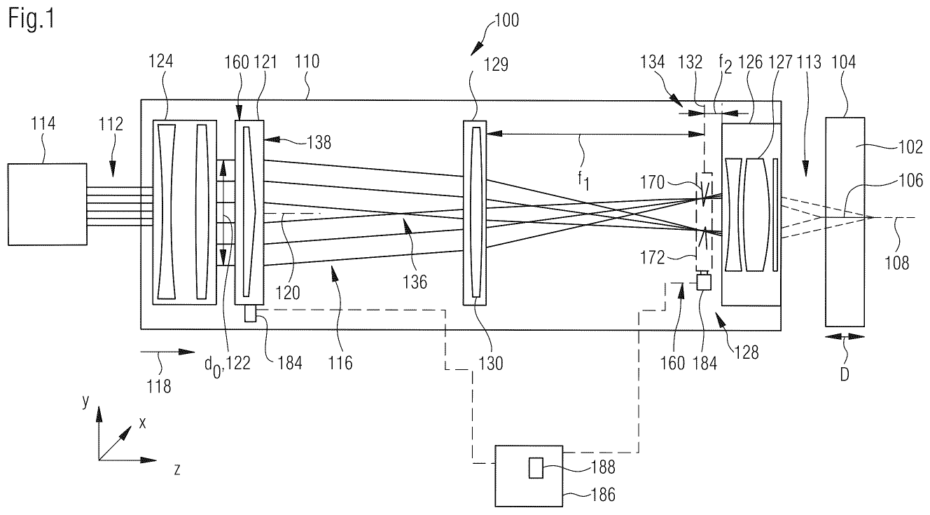

One exemplary embodiment of an apparatus for the laser processing of a workpiece is shown in FIG. 1 and is denoted by 100 in that figure. The apparatus 100 can be used to create localized material modifications in a material 102 of the workpiece 104, such as for example defects on the submicron scale or on the atomic scale which weaken the material. The workpiece 104 can be separated at these material modifications. By way of example, by means of the material modifications formed, a workpiece segment can be separated from the workpiece 104.

A focus zone 106 is formed by means of the apparatus 100, and impinges on the material 102 of the workpiece 104 for the purpose of forming material modifications. The focus zone 106 extends along a longitudinal axis 108. The focus zone 106 is formed in long-drawn-out and/or elongate fashion parallel to the longitudinal axis 108.

In particular, the focus zone 106 comprises a plurality of focus points adjacent to one another or is formed from a plurality of focus points adjacent to one another.

The workpiece 104 is formed for example in planar and/or sheetlike fashion. The workpiece 104 has a thickness D, for example, which is in particular at least approximately constant.

The workpiece 104 is produced from a transparent material 102, i.e. the material 102 is transparent to a wavelength of a laser beam used to form the focus zone 106.

In particular, the longitudinal axis 108 of the focus zone 106 is oriented parallel or transversely to a thickness direction of the thickness D of the workpiece 104. By way of example, the focus zone 106 extends at least over the entire thickness D of the workpiece 104 and/or of a workpiece segment to be separated. A total length of the focus zone 106 oriented parallel to the longitudinal axis 108 is for example greater than or equal to the entire thickness D of the workpiece 104 and/or of a workpiece segment to be separated.

For the purpose of forming the focus zone 106, the apparatus 100 comprises a beam shaping device 110. An input laser beam 112 provided by means of a laser source 114, for example, is coupled into said beam shaping device 110. Said input laser beam 112 has a wavelength to which the material 102 of the workpiece 104 is transparent.

Said input laser beam 112 is in particular a pulsed laser beam and in particular an ultrashort pulse laser beam. For example, the input laser beam 112 is a Gaussian beam and/or has a Gaussian beam profile.

After being coupled into the beam shaping device 110, the input laser beam 112 propagates through the beam shaping device 110 and is coupled out from the beam shaping device 110 as a focused output laser beam 113. The output laser beam 113 forms the focus zone 106 that impinges on the material 102 of the workpiece 104.

That part of the input laser beam 112 which propagates through the beam shaping device 110 is referred to hereinafter as laser beam 116.

The laser beam 116 has a principal direction of propagation 118, with which it propagates through the beam shaping device 110. The principal direction of propagation 118 is oriented in particular parallel to a beam axis 120 of the laser beam 116. Said beam axis 120 should be understood to mean in particular a longitudinal central axis of the laser beam 116.

For the beam shaping of the laser beam 116, the beam shaping device 110 comprises a beam shaping element 121, formed for example as a diffractive optical element and/or as an axicon element. In principle, it is also possible for the beam shaping element 121 to be embodied as a refractive or reflective element.

The beam shaping element 121 is not necessarily restricted to a single element and/or a single component. In principle, the beam shaping element 121 can comprise a plurality of subelements and/or subcomponents.

A phase imposition on a transverse beam cross-section 122 of the input laser beam 112 and/or of the laser beam 116 is effected by means of the beam shaping element 121, wherein the phase imposition is such that the laser beam 116 coupled out from the beam shaping element 121 has a quasi-nondiffractive and/or Bessel-like beam profile.

With regard to the definition and properties of quasi-nondiffractive beams, reference is made to the following book: “Structured Light Fields: Applications in Optical Trapping, Manipulation and Organisation”, M. Wordemann, Springer Science & Business Media (2012), ISBN 978-3-642-29322-1, and also to the scientific publication “Bessel-like optical beams with arbitrary trajectories” by I. Chremmos et al., Optics Letters, Vol. 37, No. 23, Dec. 1, 2012.

With regard to the formation and properties of quasi-nondiffractive and/or Bessel-like beams with an asymmetric cross-section, reference is made to the scientific publication “Generalized axicon-based generation of nondiffracting beams” by K. Chen et al., arXiv:1911.03103v1 [physics.optics], Nov. 8, 2019.

A transverse direction should be understood to mean a direction which lies in a plane oriented perpendicularly to the principal direction of propagation 118 and/or to the beam axis 120.

Provision can be made for the beam shaping device 110 to have an adapting optical unit 124 for adapting a diameter do of the beam cross-section 122. By adapting the diameter do of the laser beam 116 incident on the beam shaping element 121, it is possible to adapt in particular the total length of the focus zone 106. By way of example, the adapting optical unit 124 is formed as a telescope or comprises a telescope.

The adapting optical unit 124 is arranged upstream of the beam shaping element 121 in relation to the principal direction of propagation 118.

The beam shaping device 110 comprises a focusing optical unit 126 in order to focus the laser beam 116 coupled out from the beam shaping element 121 for the purpose of forming the focus zone 106.

The focusing optical unit 126 comprises one or more lens elements 127, for example.

By way of example, the focusing optical unit is in the form of an objective.

In particular, the focusing optical unit 126 is part of a telescope device 128 of the beam shaping device 110, wherein the laser beam 116 coupled out from the beam shaping element 121 is focused into the focus zone 106 by means of this telescope device 128.

In the exemplary embodiment in accordance with FIG. 1, the telescope device 128 comprises a lens optical unit 129 arranged at a distance from the focusing optical unit 126. Said lens optical unit 129 is or comprises for example at least one lens element 130 in the form of a converging lens, for example.

In relation to the principal direction of propagation 118, the lens optical unit 129 is arranged upstream of the focusing optical unit 126 and/or between the beam shaping element 121 and the focusing optical unit 126.

The lens optical unit 129 has a first focal length f₁ and the focusing optical unit 126 has a second focal length f₂, wherein the first focal length f₁ is greater than the second focal length f₂.

A focal plane 132 is assigned to the focusing optical unit 126 and/or to the telescope device 128. Said focal plane is positioned in a far field region 134 assigned to the focusing optical unit 126 and or to the telescope device 128.

In particular, the focal plane 132 and/or the far field region 134 are/is positioned between the lens optical unit 129 and the focusing optical unit 126 in relation to the principal direction of propagation 118.

In particular, the focal plane 132 is a common focal plane of the lens optical unit 129 and the focusing optical unit 126. By way of example, the focal plane 132 is spaced apart from the lens optical unit 129 with the first focal length f₁ and spaced apart from the focusing optical unit 126 with the second focal length f₂.

In the embodiment of the beam shaping device 110 shown in FIG. 1, an intermediate image 136 assigned to the focus zone 106 is formed, for example, which is arranged downstream of the beam shaping element 121 and/or between the beam shaping element 121 and the focusing optical unit 126 in relation to the principal direction of propagation 118, in particular.

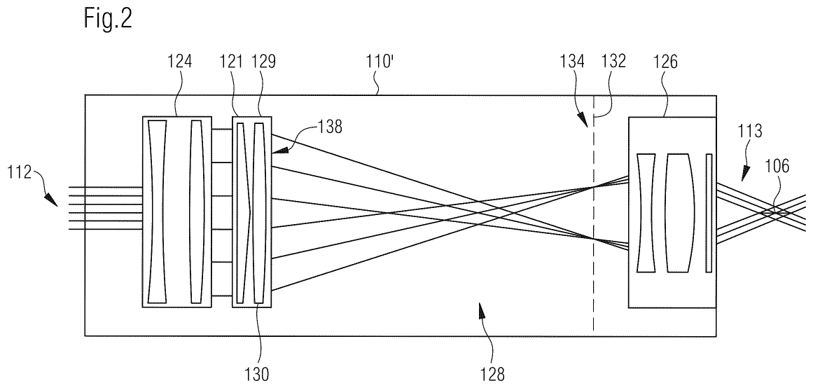

A further embodiment of a beam shaping device 110′ as shown in FIG. 2 differs from the above-described embodiment of the beam shaping device 110 essentially in that the lens optical unit 129 is integrated into the beam shaping element 121 and/or forms a unit with the beam shaping element 121.

By way of example, a functionality of the lens optical unit 129 is integrated into the beam shaping element 121. By way of example, the phase distribution imposed on the beam cross-section 122 by means of the beam shaping element 121 is adapted for the purpose of integrating the lens optical unit 129 into the beam shaping element 121.

Provision can be made for the lens optical unit 129 and/or a lens element 130 of the lens optical unit 129 to be arranged at a beam exit side 138 of the beam shaping element 121.

Otherwise, the beam shaping device 110′ fundamentally has the same set-up and the same mode of operation as the beam shaping device 110, and therefore reference is made to the description thereof in this respect.

In particular, the beam shaping device 110′ has one or more further features and/or advantages of the beam shaping device 110.

The focus zone 106 formed by means of the beam shaping device 110 has a long-drawn-out and/or elongate shape in relation to its longitudinal axis 108. This is realized by the phase imposition by means of the beam shaping element 121, wherein in particular a quasi-nondiffractive and/or Bessel-like beam profile is produced by the phase imposition by means of the beam shaping element 121.

Furthermore, a cross-section 140 of the focus zone 106 is formed in asymmetric fashion, a cross-sectional plane assigned to the cross-section 140 being oriented perpendicularly to the longitudinal axis 108.

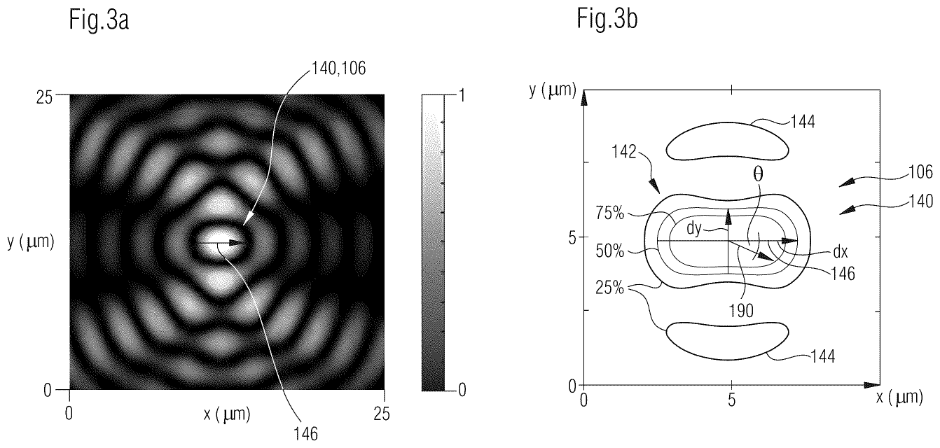

A simulated intensity distribution of the asymmetric cross-section 140 of the focus zone 106 is shown in the form of a grayscale representation in FIG. 3a, for example. In this grayscale representation, brighter regions denote regions of higher intensities.

In order to ascertain spatial dimensions of the focus zone 106, such as, for example, the total length thereof in the direction of the longitudinal axis 108 and/or a diameter dₓ, d_{y} of the cross-section 140 in an x-direction and a y-direction, respectively, oriented perpendicularly to the longitudinal axis 108, consideration is given to a modified intensity distribution having only intensity values that lie above a specific intensity threshold. In particular, said intensity threshold is 50% of a global intensity maximum of the actual intensity distribution. This is illustrated schematically in FIG. 3b for the diameters dₓ, d_{y} of the cross-section 140 of the focus zone 106.

The total length of the focus zone should be understood to mean for example a maximum length of extent and/or a length of maximum extent of the focus zone 106 along the longitudinal axis 108, taking said modified intensity distribution as a basis. Accordingly, the diameter dₓ and d_{y} should be understood to mean a maximum length of extent and/or a length of maximum extent of the cross-section 140 of the focus zone 106 in the x-direction and y-direction, respectively.

The focus zone 106 should be understood to mean in particular a global maximum intensity distribution 142 formed in particular in spatially continuous fashion. In particular, only this global maximum intensity distribution 142 is relevant to an interaction with the material 102 of the workpiece 104 for the purpose of forming material modifications.

The maximum intensity distribution 142 is in particular surrounded by secondary intensity distributions 144. These secondary intensity distributions 144 are in particular disposed around the maximum intensity distribution 142 and/or spaced apart from the maximum intensity distribution 142. The secondary intensity distributions 142 are or comprise in particular secondary maxima.

In particular, the secondary intensity distributions 144 are insignificant for the laser processing of the workpiece 104, since owing to their lower intensities there is no and/or negligible formation of material modifications in the material 102.

The asymmetric cross-section 140 of the focus zone 106 has a preferred direction 146 lying in a plane oriented perpendicularly to the longitudinal axis 108 of the focus zone 106. In particular, the preferred direction 146 should be understood to mean a direction in which the asymmetric cross-section 140 has a largest spatial extent and/or a largest diameter.

In the case of the example shown in FIGS. 3a and 3b, the largest spatial extent and/or the largest diameter of the cross-section 140 are/is oriented parallel to the x-direction. Accordingly, the preferred direction 146 is oriented parallel to the x-direction and/or parallel to a direction of the diameter dₓ.

In particular, the cross-section 140 is formed in elliptic fashion and/or at least approximately as an ellipse. The preferred direction 146 then corresponds for example to a direction of a semi-major axis of the ellipse. By way of example, in that case the diameter dₓ is oriented parallel to the semi-major axis, and the diameter d_{y} is oriented parallel to the semi-minor axis.

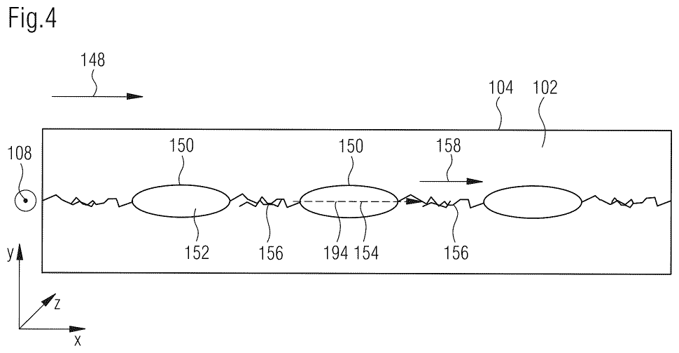

For the laser processing of the workpiece 104, the focus zone 106 impinges on the material 102 of said workpiece and the focus zone 106 is moved in an advancement direction 148 relative to the material 102 (FIG. 4).

Material modifications 150 are formed in the material 102 as a result of the focus zone 106 impinging on the material 102, which material modifications are arranged and/or lined up along the longitudinal axis 108 of the focus zone 106.

Relative movement of the focus zone 106 with respect to the material 102 results in the formation of material modifications 150 that are spaced apart in the advancement direction. A distance between material modifications 150 that are adjacent to one another parallel to the advancement direction 148 depends in particular on an advancement speed at which the focus zone 106 is moved in the advancement direction 148 relative to the material 102.

On account of the impingement of the elongate focus zone 106 on the material 102 and the relative movement of said focus zone with respect to the material 102, material modifications 150 are formed along a processing surface along which in particular the material 102 is separable. A material separation along the processing surface can be effected by a mechanical force being exerted, for example.

The material modifications 150 have a cross-section 152 having a shape corresponding to the cross-section 140 of the focus zone 106. A cross-sectional plane assigned to the cross-section 152 is oriented perpendicularly to the longitudinal axis 108 and/or parallel to the advancement direction 148 of the focus zone 106 used to form the corresponding material modification 150.

Furthermore, the cross-section 152 of a specific material modification 150 has a preferred direction 154 corresponding to the preferred direction 146 of the cross-section 140 of that focus zone 106 which was used to form the material modification 150.

In particular, the material modification 150 has a largest spatial extent and/or a largest diameter in the direction of the preferred direction 154. In the case of the example shown in FIG. 4, the cross-section 152 is in the form of an ellipse and the preferred direction 154 corresponds to a direction of a semi-major axis of the ellipse.

In particular, laser parameters assigned to the focus zone 106 are chosen such that the material modifications 150 formed in the material 102 by means of the focus zone 106 are accompanied by formation of cracks 156 in the material 102. By way of example, the material modifications 150 are type III modifications.

The cracks 156 extend in particular between mutually adjacent material modifications 150 that are spaced apart from one another in the advancement direction 148. In particular, the cracks 156 extend along a principal direction of extent 158, which are oriented at least approximately parallel to the preferred direction 154 of the material modification 150 assigned to these cracks 156 and/or are oriented at least approximately parallel to the preferred direction 146 of the focus zone 106 by means of which the material modification 150 assigned to these cracks 156 was formed.

The principal direction of extent 158 should be understood to mean in particular an average and/or averaged direction of extent of the cracks 156 assigned to a specific material modification 150.

The beam shaping device 110 comprises at least one preferred direction beam shaping element 160 for forming the asymmetric cross-section 140 of the focus zone 106 with the preferred direction 146. In particular, the preferred direction 146, preferably in a plane oriented perpendicularly to the longitudinal axis 108 of the focus zone 106, is changeable and/or adjustable by means of the preferred direction beam shaping element 160.

Provision can be made for the preferred direction beam shaping element 160 and/or a functionality of the preferred direction beam shaping element 160 to be integrated into the beam shaping element 121. By way of example, the asymmetric cross-section 140 of the focus zone 106 is realized by the phase imposition effected by means of the beam shaping element 121.

The formation of a focus zone with an asymmetric cross-section by way of phase imposition is known for example from DE 10 2019 128 362 B3.

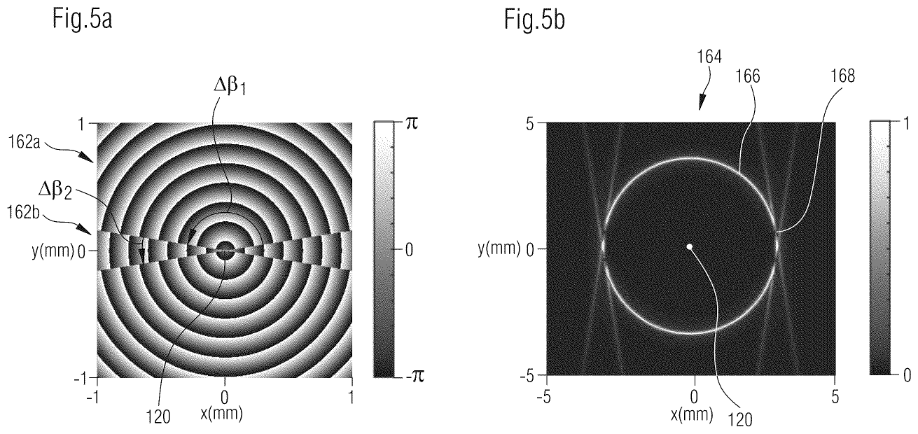

FIG. 5a shows an example of a transverse phase distribution which is imposed on the beam cross-section 122 by means of the beam shaping element 121 in order to form the focus zone 106 with an asymmetric cross-section 140. By way of example, the laser beam 116 is coupled out with this phase distribution at the beam exit side 138 of the beam shaping element 121.

By way of example, the phase distribution has a plurality of angle segments 162a, 162b, wherein mutually adjacent angle segments have different azimuthal segment widths Δβ₁, Δβ₂ and/or have a segment grating phase difference.

An example of a transverse far field intensity distribution 164 formed in the focal plane 132 and/or the far field region 134 of the beam shaping device 110 is shown in FIG. 5b. This far field intensity distribution 164 results from the phase imposition performed by means of the beam shaping element 121.

The far field intensity distribution 164 comprises a ring structure. In this embodiment, the ring structure is formed in particular as a ring segment structure and/or comprises a plurality of ring segments 166 arranged in particular concentrically in relation to the beam axis 120. In particular, all the ring segments 166 of the ring structure have an identical radius.

The ring structure of the far field intensity distribution 164 has one or a plurality of interruptions 168 arranged between mutually adjacent ring segments 166. These interruptions 168 extend in particular in one or a plurality of azimuthal angle ranges of the ring structure. In particular, at these interruptions 168, the intensity is zero or the intensity is at least 90% lower than an intensity of the adjacent ring segments 166.

The focus zone 106 is formed by the focusing of the far field intensity distribution 164 by means of the focusing optical unit 126 and/or by means of the telescope device 128. On account of the ring structure with the interruptions 168, the focus zone 106 is formed with an asymmetric cross-section 140.

In this case, the preferred direction 146 of the asymmetric cross-section 140 can be changed and/or adjusted for example by rotation of the beam shaping element 121, wherein a rotation axis in particular is oriented parallel to the beam axis 120 or corresponds to the beam axis 120.

A further embodiment provides for the preferred direction beam shaping element 160 to be or to comprise a beam stop 170 in order to form the focus zone 106 with an asymmetric cross-section 140. The beam stop 170 is configured to block one or more angle ranges of the ring structure of the far field intensity distribution 164, the blocked angle ranges of the ring structure in particular not being focused by means of the focusing optical unit 126.

The beam stop 170 is arranged in particular in the far field region 134 and/or in the focal plane 132.

By way of example, in this embodiment, the beam shaping element 121 is designed to form the far field intensity distribution 164 with a ring structure which comprises a continuous and/or interruption-free ring. Resulting interruptions 168 are then produced at this ring structure by angle ranges of the ring structure being blocked by means of the beam stop 170. As a result, the ring structure that is focused by means of the focusing optical unit 126 then comprises for example the structure shown in FIG. 5b.

In this embodiment, the preferred direction 146 of the asymmetric cross-section 140 can be changed and/or adjusted for example by way of changing the angle ranges of the ring structure of the far field intensity distribution that are blocked by means of the beam stop 170. By way of example, the blocked angle ranges can be changed by adjustment and/or rotation of the beam stop 170, a rotation axis preferably being oriented parallel to the beam axis 120 or coinciding therewith.

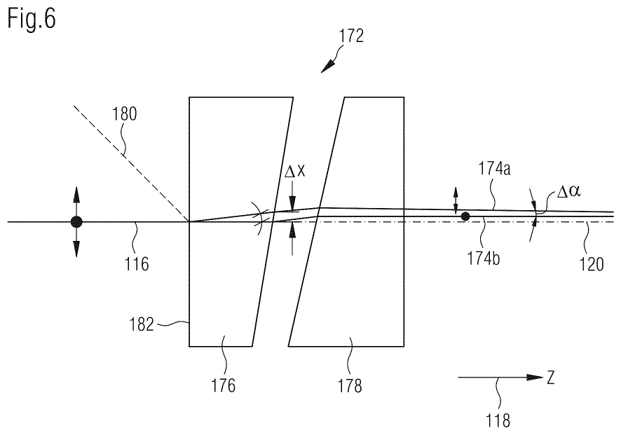

A further embodiment provides for the preferred direction beam shaping element 160 to be or to comprise at least one polarization beam splitting element 172, wherein an exemplary embodiment of the polarization beam splitting element 172 being shown in FIG. 6. The polarization beam splitting element 172 is arranged in particular in the far field region 132 and/or in the focal plane 132.

The laser beam 116 incident on the polarization beam splitting element 172 is split into mutually different partial beams 174a, 174b having different polarization states by means of the polarization beam splitting element 172.

In particular, the aforementioned polarization states should be understood to mean linear polarization states, in which case for example two different polarization states are provided and/or polarization states oriented perpendicularly to one another are provided.

In particular, beams coupled out from the polarization beam splitting element 172 are polarized in such a way that an electric field is oriented in a plane perpendicular to the principal direction of propagation 118 (transverse electric).

The partial beams 174a, 174b have a position offset Δx and an angle offset Δα, wherein in particular one of the partial beams 174a, 174b is oriented parallel to the beam axis 120 of the incident laser beam or coincides therewith.

By way of example, the polarization beam splitting element 172 comprises a birefringent polarizer element 176 and an isotropic element 178, which is arranged in particular downstream of the polarizer element 176 in relation to the principal direction of propagation 118. The polarizer element 176 and/or the isotropic element 178 are/is formed in wedge-shaped fashion, for example.

With regard to the mode of operation and embodiment of the polarization beam splitting element 128, reference is made to the German patent application with the application number 10 2020 207 715.0 (filing date: Jun. 22, 2020), in the name of the same applicant, and to DE 10 2019 217 577 A1.

An optical axis 180 of the polarizer element 176 is oriented for example at an angle of at least approximately 45° with respect to a beam entrance side 182 of the polarizer element 176 and/or with respect to the beam axis 120.

After focusing by means of the focusing optical unit 126, the polarized partial beams 174a, 174b have a position offset. In particular, the partial beams 174a, 174b are focused into different partial regions of the focus zone 106, which overlap at least in sections. It is thereby possible to form the focus zone 106 with an asymmetric cross-section 140.

In this embodiment, the preferred direction 146 of the asymmetric cross-section 140 can be changed and/or adjusted for example by rotation of the polarization beam splitting element 172, preferably about the beam axis 120 or about an axis that is parallel to the beam axis 120.

The apparatus 100 comprises an actuating device 184, by means of which the preferred direction 146 of the asymmetric cross-section 140 of the focus zone 106 is alterable during the laser processing of the workpiece 104. A change and/or adjustment of the preferred direction 146 should be understood to mean in particular that an orientation of the preferred direction 146 is changed or adjusted in a plane oriented perpendicularly to the longitudinal axis 108 of the focus zone 106.

For the purpose of altering the preferred direction 146, the actuating device 184 influences the preferred direction beam shaping element 160, such as e.g. the beam shaping element 121 and/or the beam stop 170 and/or the polarization beam splitting element 172. In particular, the preferred direction beam shaping element 160 is movable and/or rotatable by means of the actuating device 184 for the purpose of altering the preferred direction 146.

Furthermore, the apparatus 100 comprises a control device 186 connected signal-effectively to the actuating device 184. By means of this control device 186, the actuating device 184 is controllable for the purpose of altering the preferred direction 146.

Provision is made for the actuating device 184 to be controlled by means of the control device 186 on the basis of an assignment specification. This assignment specification is stored in a database 188, in particular, which is comprised by the control device 186 or to which the control device 186 is connected signal-effectively.

During operation of the apparatus 100, the preferred direction 146 is controlled by means of the control device 186 in particular in such a way that the preferred direction 146 is oriented parallel or approximately parallel to the advancement direction 148. For this purpose, the control device 186 controls the actuating device 184 on the basis of the assignment specification with a control signal in order to bring about the corresponding orientation of the preferred direction 146.

The assignment specification is or comprises for example an assignment table containing an assignment of control signal values of the control signal to orientation values of the preferred direction 146.

The orientation values of the preferred direction 146 can be indicated for example as angle indications of an angle θ with respect to a reference direction 190, the reference direction 190 lying in a plane oriented perpendicularly to the longitudinal central axis 108.

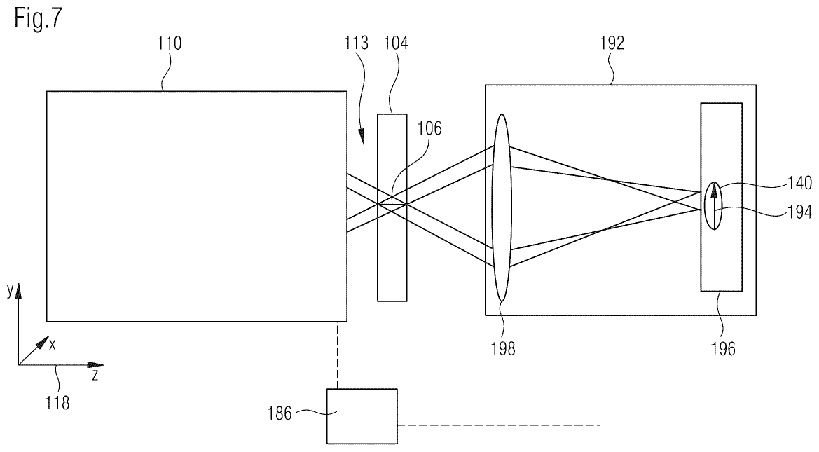

The apparatus 100 comprises a capturing device 192, by means of which an actual preferred direction 194 (indicated in FIG. 7) of the cross-section 140 of the focus zone 106 formed is optically capturable.

The actual preferred direction 194 should be understood to mean in particular a real preferred direction of the cross-section 140 such as is present in the material 102 and/or is determined by means of the capturing device 192, for example.

In the case of the example shown in FIG. 7, the focus zone 106 is formed by means of the beam shaping device 110 and the focus zone 106 impinges on the workpiece 104. The focus zone 106 formed is optically captured by means of the capturing device 192.

For the purpose of optically capturing the focus zone 106 formed, the capturing device 192 comprises an image recording device 196, in particular, which comprises for example an image sensor and/or a camera. Furthermore, the capturing device 192 comprises an imaging optical unit 198, in particular, in order to image the focus zone 106 formed by means of the beam shaping device 110 onto the image recording device 196.

In relation to the principal direction of propagation 118 of the output laser beam 113 coupled out from the beam shaping device 110, the capturing device 192 is arranged in particular downstream of the workpiece 104 and/or the focus zone 106 formed.

The actual preferred direction 194 can be determined by evaluation of image data captured by means of the image recording device 196, wherein the evaluation can be effected by means of the control device 186, for example. In particular, the capturing device 192 is then connected signal-effectively to the control device 186.

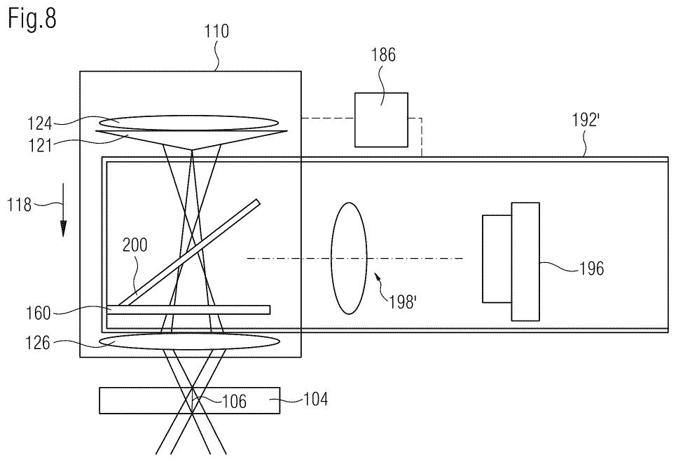

A further embodiment of an optical capturing device 192′ is shown in FIG. 8 and differs from the capturing device 192 described above essentially in that, in the case of the capturing device 192′, a material modification 150 formed in the material 102 of the workpiece 104 by means of the focus zone 106 is optically captured in order to determine the preferred direction 154 of said material modification (cf. FIG. 4).

Otherwise, the capturing device 192′ has in particular one or more features and/or advantages of the capturing device 192, and so in this respect reference is made to the above description thereof.

In this embodiment, by way of capturing the preferred direction 154 of the cross-section 152 of a material modification 150 formed by means of the focus zone 106, the actual preferred direction 194 of the focus zone 106 which was used to form this material modification 150 is deduced. In the context of this embodiment, the preferred direction 154 of the assigned material modification 150 corresponds to the actual preferred direction 194 and/or the real preferred direction of the focus zone 106 which was used to form this material modification 150.

The capturing device 192′ comprises for example the image recording device 196 and an imaging optical unit 198′ in order to image the material modification 150 onto the image recording device 196. The image recording device 196 is used to optically capture in particular the cross-section 152 of the material modification 150 and/or the cracks 156 assigned to the material modification 150.

The preferred direction 154 and/or the actual preferred direction 194 can be determined by evaluation of image data captured by means of the image recording device 196. Provision can be made for the actual preferred direction 194 of a specific material modification 150 to be determined by using the principal direction of extent 158 of cracks 156 assigned to this material modification 150.

In the exemplary embodiment in accordance with FIG. 8, the material modifications 150 formed in the material 102 are captured by way of reflected-light microscopy.

By way of example, the focusing optical unit 126 of the beam shaping device 110 serves as an objective of the imaging optical unit 198′. The beams incident on the focusing optical unit 126 from the workpiece 104 are deflected in the direction of the image recording device 196 for example by means of a partly reflective element 200 of the imaging optical unit 198′.

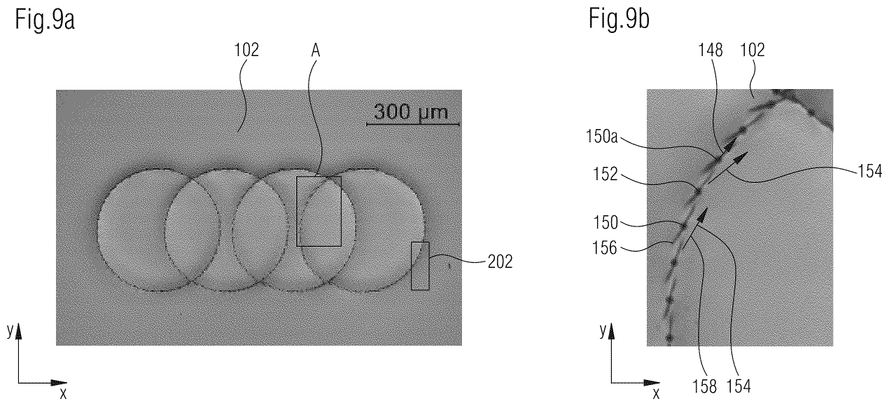

FIGS. 9a and 9b show exemplary micrographs of the material 102 with material modifications 150 formed therein, the material modifications 150 being arranged in circular fashion in the example shown.

In particular, the principal direction of extent 158 of the cracks 156 of an assigned material modification corresponds at least approximately to the preferred direction 154 of the cross-section 152 of this material modification.

The apparatus 100 operates as follows:

For the purpose of determining the assignment specification taken as a basis for the open-loop control and/or closed-loop control of the preferred direction 146 by means of the control device 186, the actuating device 184 is controlled by the control device 186 with different control signal values, for example, and the actual preferred direction 194 is determined in each case for the different control signal values. In this case, the actual preferred direction 194 is determined by means of the capturing device 192, 192′.

As a result, the assignment specification is determined in the form of a relationship between different control signal values and orientation values of the actual preferred direction 194. The assignment specification contains in particular that information concerning the control signal value with which the actuating device 184 has to be controlled in order to realize a specific actual preferred direction 194.

In the case of the capturing device 192, the actual preferred direction 194 is determined for example by optical capture and evaluation of the cross-section 140 of the focus zone 106 formed by means of the beam shaping device 110. The cross-section 140 of the focus zone 106 can be optically captured for example within or outside the material 102 of the workpiece 104. By way of example, the cross-section 140 is captured in air.

In the case of the capturing device 192′, the actual preferred direction 194 is determined for example by optical capture and evaluation of the cross-section 152 of material modifications 150 which are formed or were formed by means of the focus zone 106 in conjunction with different control signal values.

By way of example, FIG. 9b shows a plurality of material modifications 150 which are arranged at different positions in the material 102 of the workpiece 104 and were formed in conjunction with different control signal values or preferred directions 146. The actual preferred direction 194 is determined for example by optical capture and evaluation of the material modifications 150 formed in the material 102, wherein the actual preferred direction 194 of a specific material modification is determined by optically capturing and/or evaluating in particular the cross-section 152 of this material modification and/or the principal direction of extent 158 of cracks 156 assigned to this material modification 150.

The assignment specification can be determined, in principle, before or during the laser processing of the workpiece 104.

In order to carry out the laser processing, the focus zone 106 impinges on the material 102 of the workpiece 104 and the focus zone 106 is moved relative to the workpiece 104 and through the material 102 thereof in the advancement direction 148.

The material 102 is a material that is transparent to a wavelength of the input laser beam 112 and/or of the laser beam 116 from which the focus zone 106 is formed by means of the beam shaping device 110. For example, the material 102 is a glass material, e.g. quartz glass.

By way of relative movement of the focus zone 106 with respect to the material 102, material modifications 150 are formed which, as described above, are arranged along a processing surface.

The distance between adjacent material modifications 150 in the advancement direction 148 can be defined for example by way of adjusting a pulse duration of the input laser beam 112 and/or by way of adjusting the advancement speed.

The material modifications 150 formed along the processing surface result in a reduction in a strength of the material 102, in particular. This makes it possible to separate the material 102 into two mutually different workpiece segments after formation of the material modifications 150 at the processing surface, for example by a mechanical force being exerted.

It is advantageous if the preferred direction 146 of the asymmetric cross-section 140 of the focus zone 106 is aligned parallel or approximately parallel to the advancement direction 148 during the laser processing of the workpiece 104. This results in a smoother separating surface upon separation of the workpiece 104 along the processing surface.

In the case of the material modification 150a shown in FIG. 9b, the advancement direction 148 during formation of this material modification 150a was for example not oriented approximately parallel to the advancement direction 148. In particular, the principal direction of extent 158 of cracks 156 assigned to the material modification 150a is then also not oriented approximately parallel to the advancement direction 148. This can result in unevennesses upon separation of the workpiece.

In particular, provision is therefore made for the preferred direction 146 to be controlled by open-loop control and/or closed-loop control by means of the control device 186 such that the preferred direction 146 is oriented parallel or approximately parallel to the advancement direction 148 during the laser processing of the workpiece 104. Cracks 156 of material modifications 150 that are adjacent to one another then merge into one another in particular at least approximately continuously and/or without interruptions, with the result that in particular separation of the workpiece with a smooth separating surface is able to be realized (see e.g. the partial region 202 identified in FIG. 9a).

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Δα Angle offset
Δβ₁ Azimuthal segment width
Δβ₂ Azimuthal segment width
D Thickness
dₓ Diameter in the x-direction
d_{y} Diameter in the y-direction
f₁ First focal length
f₂ Second focal length
θ Angle
Δx Position offset
100 Apparatus
102 Material
104 Workpiece
106 Focus zone
108 Longitudinal axis
110 Beam shaping device
110′ Beam shaping device
112 Input laser beam
113 Output laser beam
114 Laser source
116 Laser beam
118 Principal direction of propagation
120 Beam axis
121 Beam shaping element
122 Beam cross-section
124 Adapting optical unit
126 Focusing optical unit
127 Lens element
128 Telescope device
129 Lens optical unit
130 Lens element
132 Focal plane
134 Far field region
136 Intermediate image
138 Beam exit side
140 Cross-section
142 Maximum intensity distribution
144 Secondary intensity distribution
146 Preferred direction
148 Advancement direction
150 Material modification
150a Material modification
152 Cross-section
154 Preferred direction
156 Crack
158 Principal direction of extent
160 Preferred direction beam shaping element
162a Angle segment
162b Angle segment
164 Far field intensity distribution
166 Ring segment
168 Interruption
170 Beam stop
172 Polarization beam splitting element
174a Partial beam
174b Partial beam
176 Polarizer element
178 Isotropic element
180 Optical axis
182 Beam entrance side
184 Actuating device
186 Control device
188 Database
190 Reference direction
192 Capturing device
192′ Capturing device
194 Actual preferred direction
196 Image recording device
198′ Imaging optical unit
200 Partly reflective element
202 Partial region

1. An apparatus for laser processing of a workpiece, wherein the workpiece comprises a transparent material, the apparatus comprising
a beam shaping device for forming a focus zone from an input laser beam, wherein the focus zone is formed in elongate fashion in relation to a longitudinal axis, and wherein the focus zone has, in a plain perpendicular to the longitudinal axis, an asymmetric cross-section with a preferred direction,
an actuating device for altering the preferred direction during the laser processing of the workpiece, and
a control device for controlling the actuating device based on a predefined assignment specification in order to control the preferred direction by open-loop control or closed-loop control during the laser processing of the workpiece.

2. The apparatus as claimed in claim 1, wherein the control device is configured to align the preferred direction during the laser processing at least approximately parallel to an advancement direction in which the focus zone is moved relative to the workpiece for the laser processing of the workpiece.

3. The apparatus as claimed in claim 1, wherein the beam shaping device comprises at least one beam shaping element for imposing a transverse phase distribution on a beam cross-section of the input laser beam, wherein the phase distribution is chosen in order to form the focus zone in elongate fashion, and wherein the at least one beam shaping element is formed as a diffractive optical element and/or as an axicon.

4. The apparatus as claimed in claim 3, wherein the phase distribution is chosen in such a way that the focus zone is formed with the asymmetric cross-section as a result of the imposition of the phase distribution by the at least one beam shaping element.

5. The apparatus as claimed in claim 4, wherein the at least one beam shaping element is influenceable by the actuating device for altering the preferred direction of the asymmetric cross-section of the focus zone.

6. The apparatus as claimed in claim 5, wherein the at least one beam shaping element is rotatable by the actuating device for altering the preferred direction of the asymmetric cross-section of the focus zone.

7. The apparatus as claimed in claim 1, wherein the beam shaping device comprises a polarization beam splitter for forming partial beams having at least two mutually different polarization states, wherein the focus zone is formed with the asymmetric cross-section as a result of focusing the partial beams.

8. The apparatus as claimed in claim 7, wherein the polarization beam splitter is influenceable by the actuating device for altering the preferred direction of the asymmetric cross-section of the focus zone.

9. The apparatus as claim in claim 7, wherein the polarization beam splitter is rotatable by the actuating device for altering the preferred direction of the asymmetric cross-section of the focus zone.

10. The apparatus as claimed in claim 1, wherein the beam shaping device comprises a beam stop for forming the asymmetric cross-section of the focus zone, wherein an angle range of a far field intensity distribution formed by the beam shaping device is blocked by the beam stop, wherein a non-blocked portion of the far field intensity distribution is focused for forming the elongate focus zone with the asymmetric cross-section.

11. The apparatus as claimed in claim 10, wherein the beam stop is influenceable by the actuating device for altering the preferred direction of the asymmetric cross-section of the focus zone, and wherein the angle range of the far field intensity distribution that is blocked by the beam stop is alterable by the actuating device.

12. The apparatus as claimed in claim 1, wherein a far field intensity distribution is formed by the beam shaping device, wherein the focus zone is formed by focusing of the far field intensity distribution, and wherein the far field intensity distribution focused for forming the focus zone is influenceable by the actuating device in order to alter the preferred direction of the asymmetric cross-section of the focus zone.

13. The apparatus as claimed in claim 1, further comprising a capturing device for optically capturing an actual preferred direction of the asymmetric cross-section of the focus zone, wherein the capturing device is communicatively connected to the control device.

14. The apparatus as claimed in claim 13, wherein the capturing device is configured for optically capturing the cross-section of the focus zone, or the capturing device is configured for optically capturing a respective cross-section of material modifications produced in the workpiece by the focus zone impinging thereon.

15. A method for laser processing of a workpiece, wherein the workpiece comprises a transparent material, the method comprising:
forming a focus zone from an input laser beam by using a beam shaping device, wherein the focus zone is formed in elongate fashion in relation to a longitudinal axis, and wherein the focus zone has, in a plain perpendicular to the longitudinal axis, an asymmetric cross-section with a preferred direction,
altering the preferred direction by using an actuating device during the laser processing of the workpiece, and
controlling the preferred direction by open-loop control or closed-loop control by using a control device during the laser processing of the workpiece, wherein the control device is configured to control the actuating device based on a predefined assignment specification.

16. The method as claimed in claim 15, wherein, the preferred direction is aligned by the control device during the laser processing of the workpiece at least approximately parallel to an advancement direction in which the focus zone is moved relative to the workpiece for the laser processing of the workpiece.

18. The method as claimed in claim 15, further comprising, for defining the assignment specification, determining an actual preferred direction of the asymmetric cross-section of the focus zone based on a control signal, wherein the actual preferred direction is used by the control device to control the actuating device for controlling the preferred direction.

19. The method as claimed in claim 18, wherein determining the actual preferred direction of the cross-section of the focus zone comprises:
optically capturing the cross-section of the focus zone, and determining the preferred direction of the optically captured cross-section, or
determining a preferred direction of a respective cross-section of one or a plurality of material modifications produced in the workpiece by the focus zone impinging thereon.

20. The method as claimed in claim 19, wherein the preferred direction of the cross-section of a specific material modification is determined by optically capturing cracks assigned to the specific material modification.
